(19) United States
(12) Patent Application Publication
(10) Pub. No.: US 2026/0339825 A1
(43) Pub. Date: Oct. 29, 2026

(54) TEST CASE GENERATION APPARATUS AND TEST CASE GENERATION METHOD

(71) Applicant: Hitachi, Ltd., Tokyo (JP)

(72) Inventors: Shinya FURUKAWA, Tokyo (JP); Yusuke ARAI, Tokyo (JP); Shinji ITOH, Tokyo (JP)

(73) Assignee: Hitachi, Ltd., Tokyo (JP)

(21) Appl. No.: 19/542,677

(22) Filed: Feb. 18, 2026

(30) Foreign Application Priority Data
Apr. 25, 2025 (JP) 2025-073764

(51) Int. Cl. G06F 11/3668

(52) U.S. Cl. CPC G06F 11/3684

(57) ABSTRACT

Test cases are efficiently generated from a software specification written in natural language. A test case generation apparatus extracts specification information related to system development from the specification, detects ambiguous expressions in the specification based on the specification information and an ambiguous expression knowledge database, and supplements the ambiguous expressions using the specification or a similar specification to generate an extended specification. The apparatus constructs conditional-branch structure information from the detected ambiguous expressions, associates descriptions in the specification and the extended specification with nodes of the conditional-branch structure, expands the conditional-branch structure into branch patterns to generate processing route information with assigned route identifiers, and generates test case information including input conditions and expected outputs based on the processing route information.

### BACKGROUND OF THE INVENTION

### Field of the Invention

The present invention relates to a test case generation apparatus that generates test cases from a specification written in natural language in an IT system development operation.

### Description of the Related Art

In recent years, efforts to accelerate software development by utilizing a large language model (LLM) have been expanding. In a test process for ensuring software quality in a series of software development processes, a need for efficiently generating test cases using the LLM has been increasing.

However, the LLM has characteristics that depend on a given prompt and context. Therefore, generated test cases require human verification in terms of accuracy and coverage. Even when test cases are automatically generated, in order to ensure that the contents satisfy all software specifications, a developer needs to manually identify and supplement processing routes, which causes a problem that a work cost increases.

In contrast, Japsanese Patent No. 7525127 discloses a method for automatically generating test cases from a software specification in a plurality of steps to reduce a work cost. This technique includes a step of outputting test categories, test viewpoints, confirmation items, and the like from contents described in a specification. By automatically generating test cases based on output results of the plurality of steps, a more efficient test process is achieved.

### SUMMARY OF THE INVENTION

When test cases are automatically generated for software by using a large language model (LLM), it is necessary to ensure accuracy and coverage of the test cases with respect to processing contents described in a specification.

When a technique described in Japanese Patent No. 7525127 is used, the following problems may arise. First, it is necessary to input an entire design document and information required for test generation into the LLM in a large amount each time, which increases an amount of input data to the LLM, degrades inference capability, and may cause hallucination. In particular, as description in the specification becomes more complex, the LLM needs to perform a large amount of inference, and a possibility of obtaining accurate test cases becomes lower.

Second, it is difficult to quantitatively indicate whether test cases generated by the LLM actually cover all branches. Therefore, an engineer needs to manually identify what kinds of branches exist and then compare the generated test cases with the identified branches to confirm coverage, which causes redundant work.

As described above, it is necessary to solve the above problems, achieve higher accuracy and enhanced coverage in test case generation using the LLM, and reduce man-hours required for manually identifying processing routes and adding or correcting test cases. Accordingly, an object of the present invention is to efficiently generate test cases from a software specification written in natural language.

According to one embodiment of the present invention, a test case generation apparatus is a test case generation apparatus that generates test cases from a specification written in natural language, the test case generation apparatus comprising:
a specification collection unit configured to extract specification information related to system development from the specification;
a specification extension unit configured to generate ambiguous expression detection information including ambiguous expressions in the specification and corrected expressions thereof based on the specification information and an ambiguous expression knowledge database, and to supplement the ambiguous expressions included in the ambiguous expression detection information using the specification or a similar specification that is similar to the specification to a certain extent, thereby generating an extended specification;
a conditional branching structure generation unit configured to generate conditional branching structure information by constructing a conditional branching structure from the ambiguous expression detection information;
a mapping relationship generation unit configured to generate mapping relationship information that associates descriptions in the specification and descriptions in the extended specification with node information related to node types extracted from the conditional branching structure information;
route information generation unit configured to scan the conditional branching structure information, expand the conditional branching structure into branching patterns, and generate processing route information in which a route ID is assigned to each branching pattern; and
a test case generation unit configured to generate test case information including input conditions and expected outputs based on completed mapping relationship information and the processing route information.

According to the present invention, test cases may be efficiently generated from a software specification written in natural language.

### BRIEF DESCRIPTION OF THE DRAWINGS

FIG. 1 is a diagram illustrating an example of a configuration of a test case generation system according to a first embodiment.

FIG. 2 is a functional block diagram illustrating an example of a functional configuration of a test case generation apparatus according to the first embodiment.

FIG. 3 is a diagram illustrating an example of specification information according to the first embodiment.

FIG. 4 is a diagram illustrating an example of an ambiguous expression knowledge database according to the first embodiment.

FIG. 5 is a diagram illustrating an example of ambiguous expression detection information according to the first embodiment.

FIG. 6 is a diagram illustrating an example of conditional branching structure information according to the first embodiment.

FIG. 7 is a diagram illustrating an example of mapping relationship information according to the first embodiment.

FIG. 8 is a diagram illustrating an example of processing route information according to the first embodiment.

FIG. 9 is a diagram illustrating an example of test case information according to the first embodiment.

FIG. 10 is a hardware configuration diagram illustrating an example of a configuration of a computer according to the first embodiment.

FIG. 11 is a flowchart illustrating an example of an overall processing flow of test case generation by the test case generation apparatus according to the first embodiment.

FIG. 12 is a flowchart illustrating an example of detecting and supplementing ambiguous portions by the test case generation apparatus according to the first embodiment.

FIG. 13 is a flowchart illustrating an example of processing for mapping a conditional branching structure and a specification by the test case generation apparatus according to the first embodiment.

FIG. 14 is a flowchart illustrating an example of processing for assigning all route IDs to a conditional branching structure and confirming coverage by the test case generation apparatus according to the first embodiment.

FIG. 15 is a diagram illustrating an example of a screen for performing mapping work for human review and correction by the test case generation apparatus according to the first embodiment.

FIG. 16 is a diagram illustrating an example of a screen for performing coverage confirmation for human review and correction by the test case generation apparatus according to the first embodiment.

FIG. 17 is another functional block diagram illustrating an example of a functional configuration of a test case generation apparatus according to a second embodiment.

FIG. 18 is a flowchart illustrating an example of an overall processing flow of test case generation by the test case generation apparatus according to the second embodiment.

### DESCRIPTION OF THE PREFERRED EMBODIMENTS

Hereinafter, embodiments of the present invention are described with reference to the drawings. The following description and drawings are illustrative for explaining the present invention, and omission and simplification are appropriately made for clarification of description.

The present invention may be implemented in various other forms. Unless otherwise particularly limited, each constituent element may be singular or plural. Positions, sizes, shapes, ranges, and the like of constituent elements illustrated in the drawings may not represent actual positions, sizes, shapes, ranges, and the like, in order to facilitate understanding of the invention. Accordingly, the present invention is not necessarily limited to positions, sizes, shapes, ranges, and the like disclosed in the drawings.

As examples of various types of information, expressions such as a “table”, a “list”, and a “queue” may be used for description. However, various types of information may be represented by data structures other than these. For example, various types of information such as an “XX table”, an “XX list”, and an “XX queue” may be referred to as “XX information”. When identification information is described, expressions such as “identification information”, an “identifier”, a “name”, an “ID”, and a “number” are used, and these expressions may be interchangeable with each other.

When a plurality of constituent elements having the same or similar functions are present, the constituent elements may be described by assigning the same reference sign with different subscripts. When it is not necessary to distinguish between such a plurality of constituent elements, the subscripts may be omitted.

In the following description, there may be a case where processing performed by executing a program is described. In this case, a computer or the like executes a program by a processor (for example, a CPU or a GPU) and performs processing defined by the program while using storage resources (for example, a memory) and interface devices (for example, a communication port).

Accordingly, a subject that performs processing by executing a program may be a processor. Similarly, a subject that performs processing by executing a program may be a controller, an apparatus, a system, a computer, or a node including a processor. A subject that performs processing by executing a program may be an arithmetic unit, and may include a dedicated circuit that performs specific processing. Here, the dedicated circuit includes, for example, an FPGA (Field Programmable Gate Array), an ASIC (Application Specific Integrated Circuit), or a CPLD (Complex Programmable Logic Device).

A program may be installed in a computer or the like from a program source. The program source may be, for example, a program distribution server or a storage medium readable by a computer or the like. When the program source is a program distribution server, the program distribution server includes a processor and a storage resource that stores a program to be distributed, and the processor of the program distribution server may distribute the program to another computer or the like. In an embodiment, two or more programs may be implemented as one program, or one program may be implemented as two or more programs.

### Embodiment 1

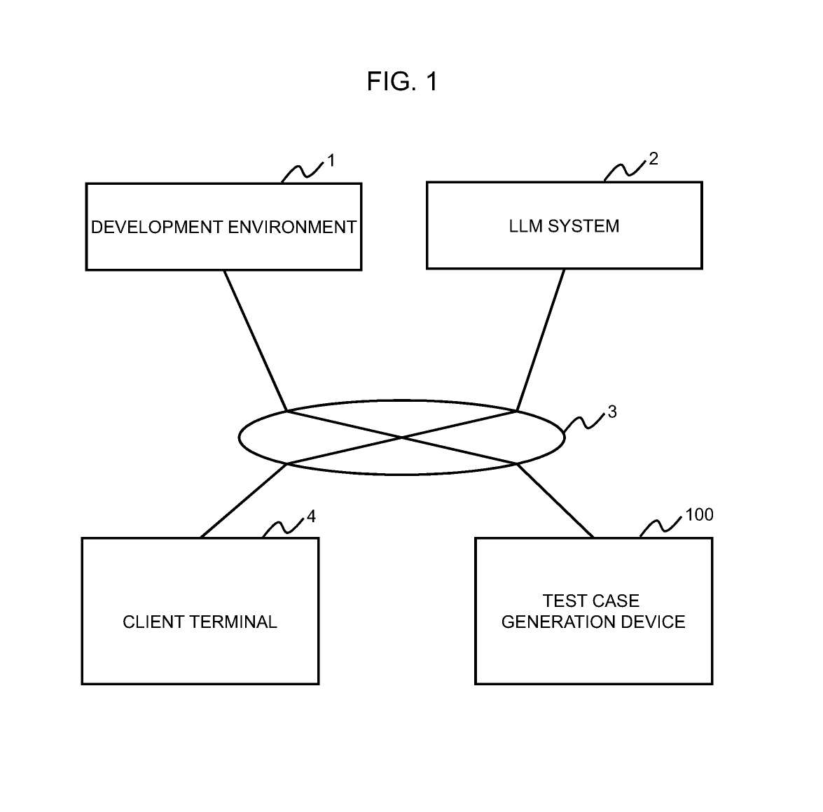

FIG. 1 is a diagram illustrating an example of a configuration of a test case generation system according to a first embodiment. The test case generation system includes a development environment 1, an LLM system 2, a client terminal 4, and a test case generation apparatus 100. The test case generation apparatus 100 is communicably connected to the development environment 1, the LLM system 2, and the client terminal via a network 3. The network 3 may be, for example, a public network such as the Internet, a LAN (Local Area Network), or a WAN (Wide Area Network).

The development environment 1 is an information processing system that stores information and deliverables related to software development, such as a specification written in natural language, source code, and test cases, for use by an engineer in developing software. The LLM system 2 has an interface function that receives an input, performs computation and inference using an LLM, and outputs a result.

The client terminal 4 is a server computer or the like that is physical computer hardware connected to the development environment 1 and the like via the network 3. The client terminal 4 outputs information to the test case generation apparatus 100 via the network 3, acquires information from the test case generation apparatus 100, and displays the acquired information.

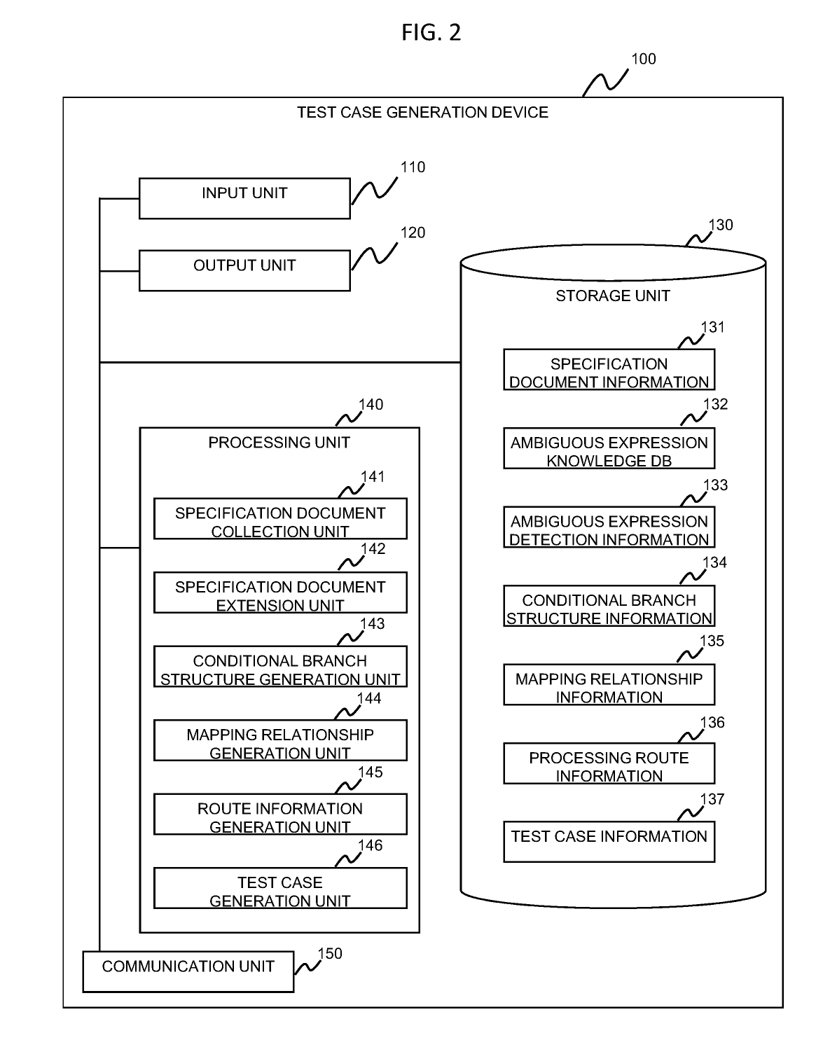

FIG. 2 is a functional block diagram illustrating an example of a functional configuration of the test case generation apparatus 100. The test case generation apparatus 100 includes an input unit 110, an output unit 120, a storage unit 130, a processing unit 140, and a communication unit 150.

The input unit 110 is a functional unit that receives input information. Specifically, the input unit 110 receives input information input by a user via an input device, such as a keyboard and a mouse, included in the test case generation apparatus 100. The input unit 110 outputs the received input information to the processing unit 140.

The output unit 120 is a functional unit that displays various types of information on a display device, such as a display, included in the test case generation apparatus 100.

The storage unit 130 is a functional unit that stores various types of information. The storage unit 130 stores specification information 131, an ambiguous expression knowledge database (DB) 132, ambiguous expression detection information 133, conditional branching structure information 134, mapping relationship information 135, processing route information 136, test case information 137, and the like.

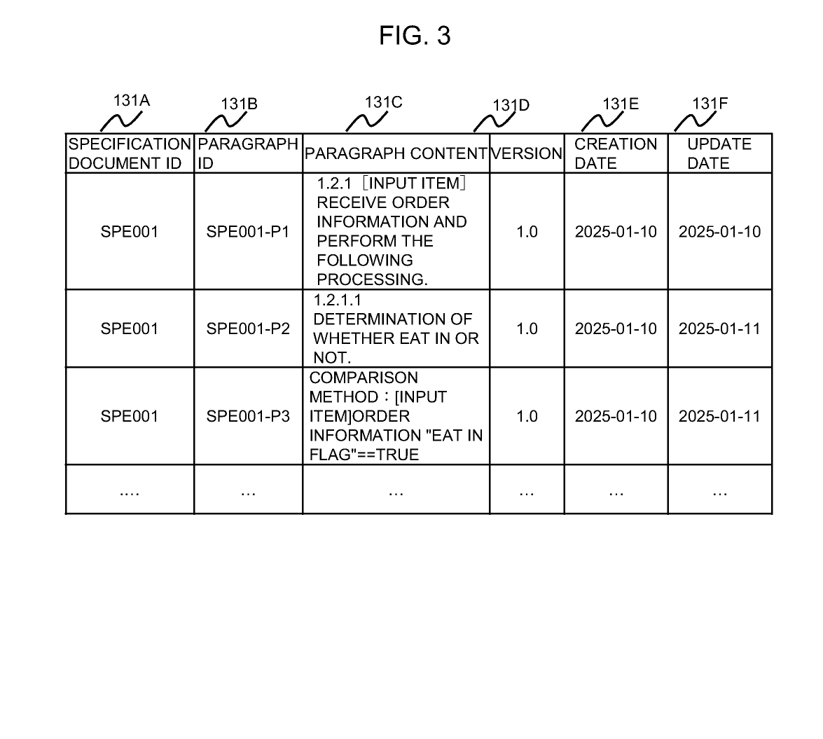

Specifically, the specification information 131 is information that manages a paragraph ID, processing contents, version information, and the like included in a specification (design document) that is natural-language text information. FIG. 3 is a diagram illustrating an example of the specification information 131.

The specification information 131 includes information for organizing each paragraph of a specification related to system development and for reference during test case generation. The specification information 131 includes fields 131A to 131F.

The field 131A stores a specification ID that uniquely identifies a specification. The field 131B stores a paragraph ID that identifies a paragraph describing a functional item, a processing step, or the like. The field 131C stores contents of the paragraph, such as processing and conditional branching, corresponding to each paragraph. The field 131D stores a version of the paragraph. The field 131E stores a creation date of the specification. The field 131F stores an update date of the specification.

For example, in a first-row record illustrated in FIG. 3, a specification ID “SPE001” is stored in the field 131A, and a paragraph ID “SPE001-P1” is stored in the field 131B. In addition, processing contents such as “1.2.1 [Input Item] Receive order information and perform the following processing.” are stored in the field 131C, and a version “1.0” is stored in the field 131D. Furthermore, a creation date “2025-01-10” is stored in the field 131E, and an update date “2025-01-10” is stored in the field 131F. In this manner, the first-row record stores specification information.

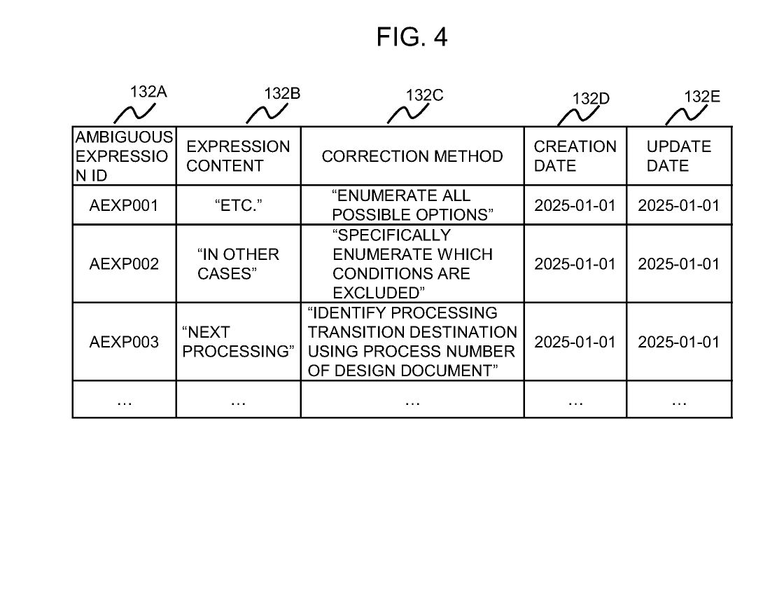

An ambiguous expression knowledge database 132 illustrated in FIG. 2 is database information in which ambiguous expressions and terms, and how to correct the ambiguous expressions and terms, are organized. FIG. 4 is a diagram illustrating an example of the ambiguous expression knowledge database 132.

The ambiguous expression knowledge database 132 stores information indicating ambiguous expressions and terms, and correction policies thereof, which are referenced when converting ambiguous descriptions in a specification into clearer contents. The ambiguous expression knowledge database 132 includes fields 132A to 132E.

The field 132A stores an ambiguous expression ID that uniquely identifies each record. The field 132B stores expression contents of a word or a sentence corresponding to an ambiguous expression. The expression contents include, for example, “and the like”, “in other cases”, and “next processing”.

The field 132C stores a correction method indicating how an ambiguous expression is to be corrected or replaced. The field 132D stores, as a creation date, a date on which the record was initially created. The field 132E stores, as an update date, a date on which contents of the record were last updated.

For example, in a first-row record illustrated in FIG. 4, an ambiguous expression ID “AEXP001” is stored in the field 132A, and expression contents “and the like” are stored in the field 132B. In addition, the field 132C indicates, as a correction method, “enumerate all possible options”, the field 132D stores a creation date “2025-01-01”, and the field 132E stores an update date “2025-01-01”.

In this manner, the first-row record stores ambiguous expression information. The ambiguous expression knowledge database 132 is used as a technique for resolving ambiguity by presenting all specific options when an expression such as “and the like” appears in a specification.

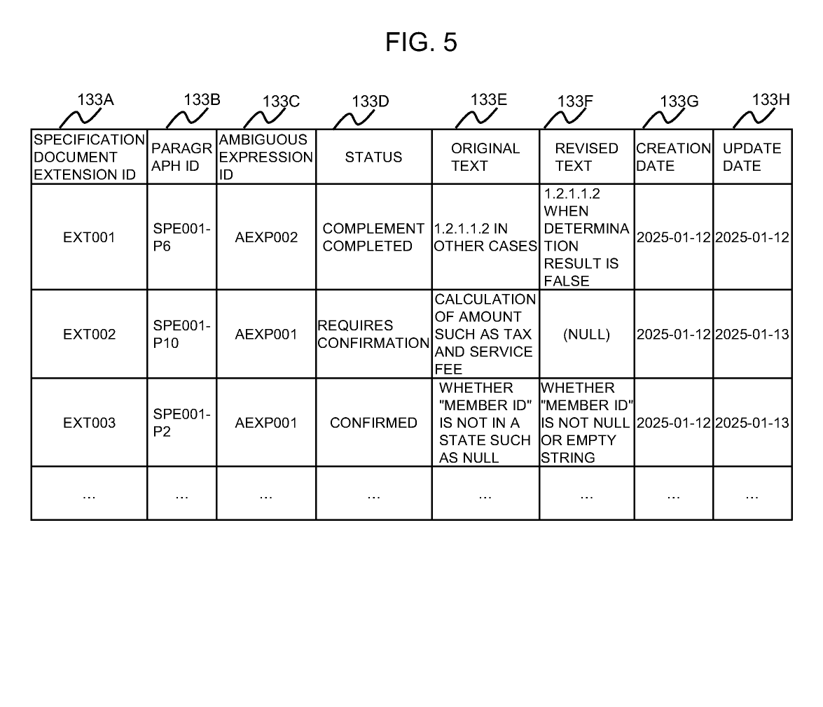

Ambiguous expression detection information 133 illustrated in FIG. 2 is information that manages ambiguous expressions actually detected from a specification, positions of the ambiguous expressions, and correction histories thereof. FIG. 5 is a diagram illustrating an example of the ambiguous expression detection information 133.

The ambiguous expression detection information 133 stores information for managing portions corresponding to ambiguous expressions in a specification, how the ambiguous expression portions are corrected, or a status indicating whether correction is required. The ambiguous expression detection information 133 includes fields 133A to 133H.

The field 133A stores a specification extension ID for managing an extended specification obtained by correcting ambiguity of existing specification information and supplementing or extending a specification. The field 133B stores a paragraph ID as an identifier that uniquely indicates a position of an ambiguous expression portion, such as a paragraph or a functional item of a specification in which an ambiguous expression is detected. The field 133C stores, as an ambiguous expression ID, an identifier of an ambiguous expression defined in the ambiguous expression knowledge database 132. The field 133D stores a status indicating progress of correction work for an ambiguous expression or whether examination is required.

The field 133E stores, as an original text, a description in an original specification that includes a detected ambiguous expression. The field 133F stores, as a corrected description, correction contents indicating how the ambiguous expression in the original text is corrected or replaced. The field 133G stores, as a creation date, a date on which the record was initially created. The field 133H stores, as an update date, a date on which contents of the record were last updated.

For example, in a first-row record illustrated in FIG. 5, “EXT001” is stored in the field 133A, “SPE001-P6” is stored in the field 133B, and “AEXP002” is stored in the field 133C. In addition, the field 133D stores a status of “completion of supplementation”, and the field 133E stores an ambiguous original description “1.2.1.1.2 in other cases”.

In contrast, the field 133F stores a corrected expression “1.2.1.1.2 when a determination result is false (FALSE)”, which indicates a description in which ambiguity is resolved by clearly specifying a more concrete condition. The field 133G and the field 133H store “2025-01-12” as a creation date and an update date. In this manner, the first-row record stores ambiguous expression detection information.

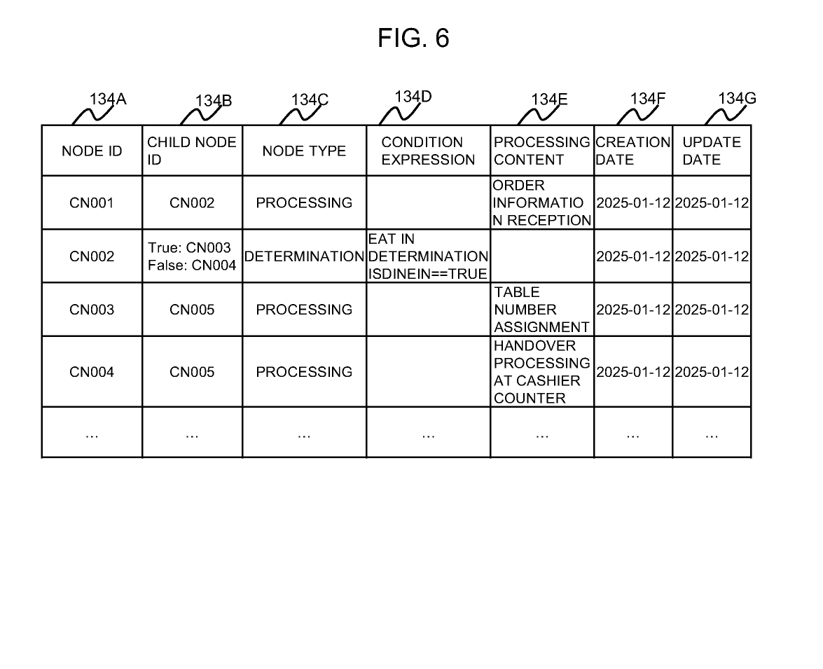

Conditional branching structure information 134 illustrated in FIG. 2 is information in which processing and determinations of a specification are represented in a tree format. FIG. 6 is a diagram illustrating an example of the conditional branching structure information 134. The conditional branching structure information 134 stores information for managing a processing flow in a system or an application on a node-by-node basis and represents branching processing in a tree structure. The conditional branching structure information 134 includes fields 134A to 134G.

The field 134A stores a node ID as an identifier for uniquely identifying each node constituting a processing flow. The field 134B stores a child node ID as an identifier indicating a node corresponding to subsequent processing of the node. The field 134C stores a node type as a role in the processing flow, such as “processing” or “determination”.

The field 134D stores, when the field 134C indicates a “determination” node, a determination condition for branching processing as a conditional expression. When the field 134C indicates “processing”, the field 134D is left blank. The field 134E stores specific processing contents executed at the node. The field 134F stores, as a creation date, a date on which information of the node was initially created. The field 134G stores, as an update date, a date on which information of the node was last updated.

For example, in a first-row record (node) illustrated in FIG. 6, “CN001” is stored in the field 134A as a node ID, and “CN002” is stored in the field 134B as a child node ID. In addition, “processing” is stored in the field 134C as a node type, and “order information reception” is stored in the field 134E as processing contents.

That is, the first node ID “CN001” is configured such that order information is received and processing then transitions to a child node “CN002” indicating subsequent processing. In this manner, the first-row record stores conditional branching structure information.

In addition, for example, when the node type in the field 134C is “determination” and includes conditional branching, a plurality of child nodes corresponding to branching destinations are present. In a second-row record, “CN002” stored in the field 134A has a node type of “determination” in the field 134C, and the field 134D has a conditional expression “dine-in determination isDineIn == True”.

This conditional expression specifies, as in the field 134B, that processing transitions to a child node “True: CN003” when a branching result is true, and transitions to a child node “False: CN004” when the branching result is false. In this manner, the second-row record stores conditional branching structure information.

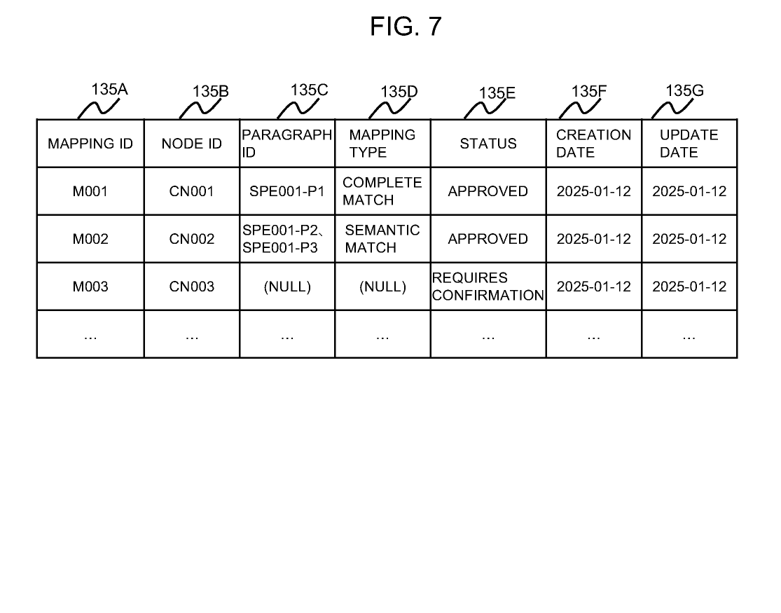

Mapping relationship information 135 illustrated in FIG. 2 is information for managing a correspondence relationship between paragraphs of a specification and respective nodes of a conditional branching structure. FIG. 7 is a diagram illustrating an example of the mapping relationship information 135.

The mapping relationship information 135 stores information for managing a correspondence relationship between paragraphs in a specification and nodes indicated by the conditional branching structure information 134. The mapping relationship information 135 includes fields 135A to 135G.

The field 135A stores a mapping ID as an identifier for uniquely identifying a record that associates a paragraph in a specification with a node of conditional branching. The field 135B stores a node ID corresponding to the node ID in the field 134A in FIG. 6. That is, the field 135B stores an identifier indicating a node in conditional branching or a processing flow.

The field 135C stores a paragraph ID for identifying a paragraph of a specification indicated by, for example, the field 131B in FIG. 3. When one node corresponds to a plurality of paragraphs, the field 135C lists a plurality of paragraph IDs, such as “SPE001-P2, SPE001-P3”.

The field 135D stores a mapping type indicating how a node matches a paragraph or a description of a specification. The field 135E stores a status indicating an approval state related to mapping or whether confirmation is required. The field 135F stores, as a creation date, a date on which the mapping record was initially created. The field 135G stores, as an update date, a date on which the mapping record was last updated.

For example, in a first-row record illustrated in FIG. 7, a mapping ID “M001” is stored in the field 135A, a node ID “CN001” is stored in the field 135B, and a paragraph ID “SPE001-P1” is stored in the field 135C. In addition, the field 135Dindicates a mapping type of “exact match”, and the field 135E stores a status of “approved”. The field 135Fand the field 135G store “2025-01-12” as a creation date and an update date. In this manner, the first-row record stores mapping relationship information.

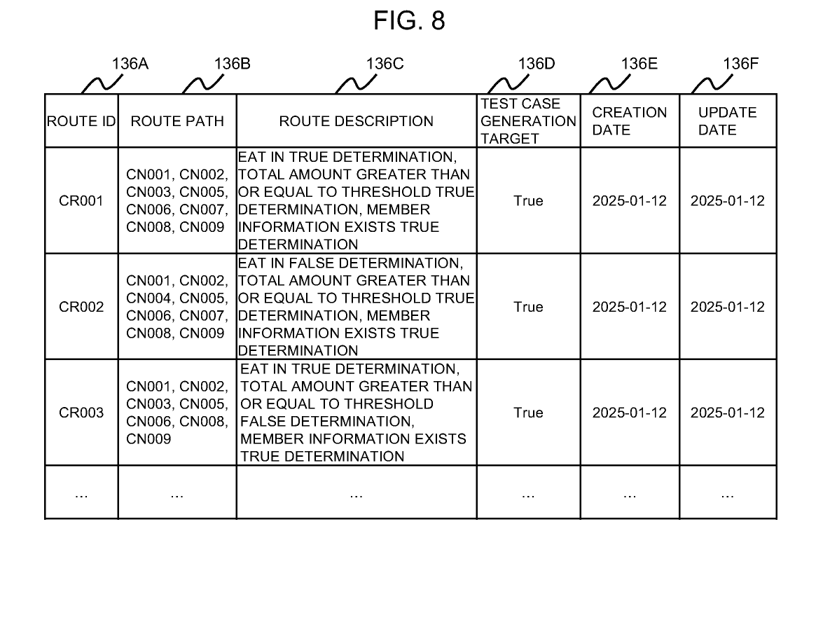

Processing route information 136 illustrated in FIG. 2 is information that enumerates execution routes (processing paths) including all branches of a conditional branching structure and manages a test case generation status for each execution route. FIG. 8 is a diagram illustrating an example of the processing route information 136.

The processing route information 136 stores information for listing specific routes (processing paths) that pass through nodes represented by the conditional branching structure information 134 and for managing a description of each route and whether a test case is generated. The processing route information 136 includes fields 136Ato 136F.

The field 136A stores a route ID as an identifier for uniquely identifying one processing route. The field 136B stores a route path as an order in which nodes constituting the route are traversed. In the field 136B, a plurality of node IDs, such as “CN001” and “CN002”, are listed, thereby clarifying an execution order from a start to an end of the route.

The field 136C stores a brief route description indicating what kinds of condition determinations (True/False) and processing steps are performed in the route. The field 136D stores a flag indicating whether the route is a target for test case generation. The field 136E stores, as a creation date, a date on which the route information was initially registered. The field 136F stores, as an update date, a date on which the route information was last updated.

For example, in a first-row record illustrated in FIG. 8, a route ID “CR001” is stored in the field 136A, and a route path “CN001, CN002, CN003, CN005, CN006, CN007, CN008, CN009” is stored in the field 136B. In addition, the field 136C stores a route description “dine-in True determination, total amount equal to or greater than a threshold True determination, member information present True determination”, which briefly indicates which conditional branches result in True or False in an execution path.

In addition, the field 136D stores “True” as an indication that the route is a target for test case generation. The field 136E and the field 136F store “2025-01-12” as a creation date and an update date. In this manner, the first-row record stores processing route information.

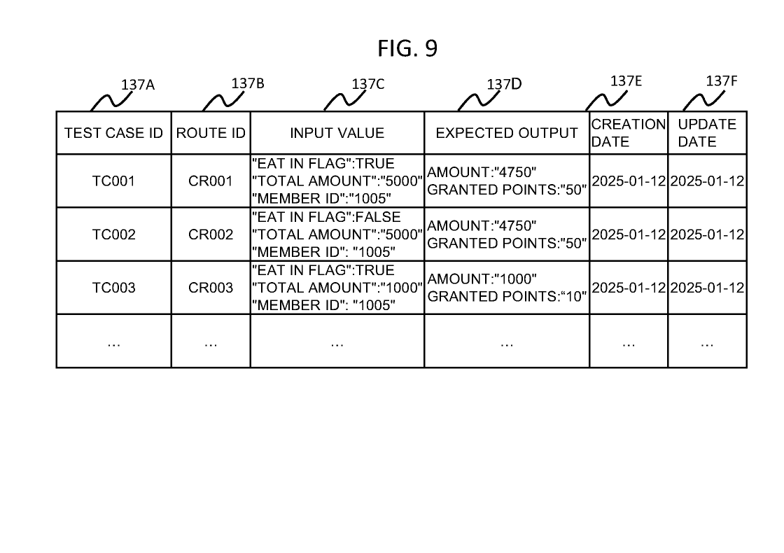

Test case information 137 illustrated in FIG. 2 is information of test cases actually generated. FIG. 9 is a diagram illustrating an example of the test case information 137. The test case information 137 stores information for managing a route (processing path) of a test case and inputs and outputs corresponding to the route. The test case information 137 includes fields 137A to 137F.

The field 137A stores a test case ID as an identifier for uniquely identifying one test case. The field 137B stores a route ID as a route constituting the test case. The field 137C stores input values required to execute the route.

The field 137D stores expected output values when the route is executed. The field 137E stores, as a creation date, a date on which the route information was initially registered. The field 137F stores, as an update date, a date on which the route information was last updated.

For example, in a first-row record illustrated in FIG. 9, a test case ID “TC001” is stored in the field 137A, and a route ID “CR001” is stored in the field 137B. In addition, the field 137C stores input values “dine-in flag: true, total amount: 5000, member ID: 1005”, and the field 137D stores expected output values “amount: 4750, granted points: 50”. The field 137E and the field 137F store “2025-01-12” as a creation date and an update date. In this manner, the first-row record stores test case information.

A processing unit 140 illustrated in FIG. 2 is a block that executes main processing logic, and includes a specification collection unit 141, a specification extension unit 142, a conditional branching structure generation unit 143, a mapping relationship generation unit 144, a route information generation unit 145, and a test case generation unit 146. In this manner, the processing unit 140 includes a plurality of functional modules.

Specifically, the specification collection unit 141 acquires a specification (design document) related to system development from the development environment 1 via the input unit 110, the communication unit 150, or the like, extracts specification information, and stores the specification information in the specification information 131 of the storage unit 130.

The specification extension unit 142 detects ambiguous expressions in the specification based on the ambiguous expression knowledge database 132 while referring to the specification information 131, and corrects the specification as an extended specification. In addition, correction results are added to the ambiguous expression detection information 133 and stored as extended specification information.

The conditional branching structure generation unit 143 extracts logic and a conditional branching structure from the ambiguous expression detection information 133 of the extended specification information, and generates the conditional branching structure information 134. The conditional branching structure information 134 is stored as a tree structure in which node types such as “determination” and “processing” are organized and branching conditional expressions are clearly defined.

The mapping relationship generation unit 144 generates and updates the mapping relationship information 135 in order to associate each paragraph of the extended specification with each node of the conditional branching structure information 134, thereby enabling tracking of which paragraph defines processing of which node.

The route information generation unit 145 refers to the conditional branching structure information 134 and generates the processing route information 136 that covers all branching patterns. The processing route information 136 enumerates node transition paths (route paths) of each route and determination results indicating whether each route is a target for test case generation to be used in subsequent test case generation.

The test case generation unit 146 confirms the processing route information 136 and the mapping relationship information 135 for which ambiguity correction is completed through human review, combines necessary test parameters (input conditions) and expected results (expected outputs), generates test cases, and records the generated test cases in the test case information 137.

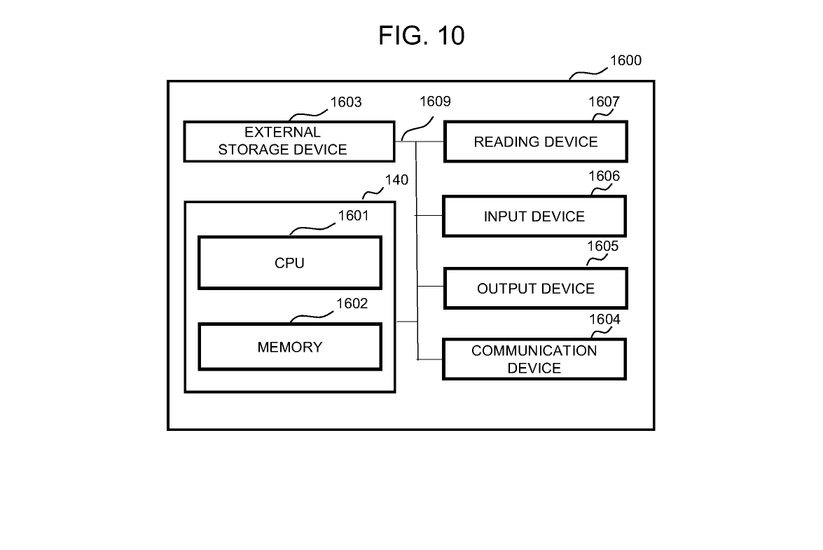

The test case generation apparatus 100 illustrated in FIG. 2 may be implemented as a general-purpose computer. FIG. 10 is a hardware configuration diagram illustrating an example of a configuration of a computer 1600. The computer 1600 includes a CPU 1601 and a memory 1602 as a main storage device functioning as the processing unit 140, and an external storage device 1603 functioning as the storage unit 130, such as an HDD (Hard Disk Drive).

In addition, the computer includes a reading and writing device 1607 that reads from and writes to a portable storage medium such as a CD (Compact Disk) or a USB memory, an input device 1606 functioning as the input unit 110 such as a scanner, a keyboard, and a mouse, and an output device 1605 functioning as the output unit 120 such as a display. Furthermore, the computer includes a communication device 1604 functioning as the communication unit 150, such as an NIC (Network Interface Card) for connecting to a communication network, and an internal communication line 1609 (referred to as a system bus) such as a system bus that connects these components.

Various types of data stored in or used for processing by the systems and apparatuses illustrated in the embodiments may be realized by the CPU 1601 reading and using the data from the memory 1602 or the external storage device 1603. In addition, each functional unit included in each system or apparatus may be realized by the CPU 1601 loading a predetermined program stored in the external storage device 1603 into the memory 1602 and executing the program.

A predetermined program may be stored (downloaded) in the external storage device 1603 from a storage medium via the reading and writing device 1607 or from a network via the communication device 1604, loaded into the memory 1602, and executed by the CPU 1601. Alternatively, the predetermined program may be directly loaded into the memory 1602 from a storage medium via the reading and writing device 1607 or from a network via the communication device 1604, and executed by the CPU 1601.

Although the computer 1600 is illustrated below as an example in which the computer 1600 is configured by a single computer, all or a part of these functions may be distributed and provided in one or a plurality of computers, such as a cloud environment, and similar functions may be realized by mutual communication via a network.

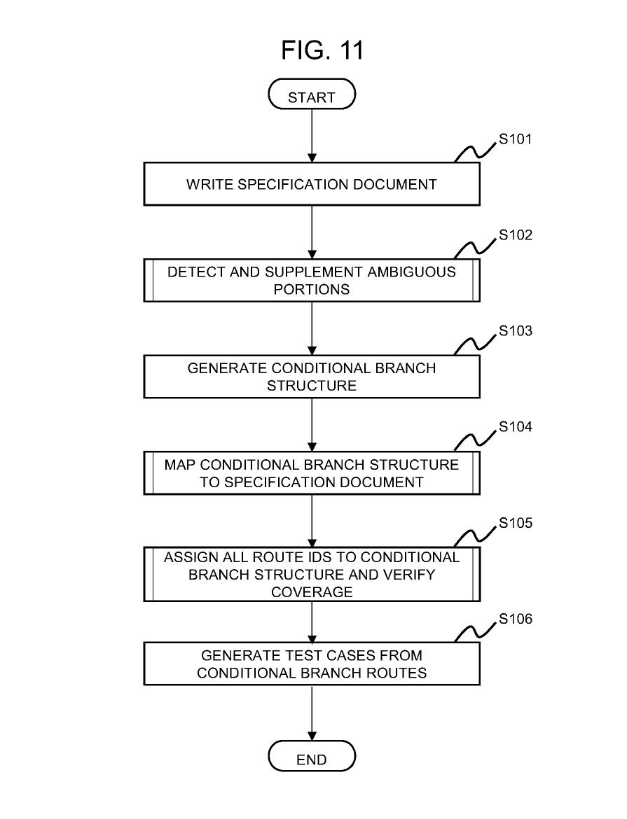

FIG. 11 is a flowchart illustrating an example of an overall processing flow of test case generation by the test case generation apparatus 100 according to one embodiment of the present invention. The following describes an outline of processing in each step (S101 to S106).

In step S101, when a test case generation process is started, the specification collection unit 141 of the test case generation apparatus 100 reads a predetermined specification (such as a design document or a related document) acquired from the development environment 1 via the input unit 110, the communication unit 150, or the like. Then, data such as information of the specification (design document) required in subsequent processes is stored in the specification information 131 of the storage unit 130 in the test case generation apparatus 100.

Next, in step S102, the specification extension unit 142 refers to the specification information 131 and the ambiguous expression knowledge database 132, analyzes contents of the specification, and detects items of ambiguous expressions including ambiguous descriptions or omissions. For example, the specification extension unit 142 performs correction by adding supplementary information (all relevant items) when an expression such as “and the like” is used, and performs correction such as clarification of a conditional expression when an expression such as “in other cases” is used, thereby generating an extended specification in which ambiguity is resolved.

In addition, the specification extension unit 142 adds and updates, for each item of the ambiguous expression detection information 133, a corrected specification corresponding to an original text of the specification. Through this step S102, specification data that is easy to interpret in a subsequent branching structure generation process (the ambiguous expression detection information 133) and an extended specification are obtained.

In step S103, the conditional branching structure generation unit 143 extracts the ambiguous expression detection information 133 of the extended specification information, organizes processing contents and conditional expressions, and stores the organized information in the conditional branching structure information 134. Specifically, the conditional branching structure generation unit 143 structures node types such as “processing” and “determination” in a tree format based on information of the corrected specification stored in the field 133F of the ambiguous expression detection information 133, and clarifies conditional expressions of respective branches. As a result, information such as node types is stored in the field 134C of the conditional branching structure information 134, thereby enabling comprehensive scenario examination of the extended specification in subsequent test case generation.

In step S104, the mapping relationship generation unit 144 generates mapping relationship information 135 indicating which paragraph (requirement) defines each node (processing or determination) based on the extended specification and the conditional branching structure information 134. In addition, the mapping relationship generation unit 144 presents, to a user, correspondence between the conditional branching structure generated in the conditional branching structure information 134 and respective paragraphs or functional requirements of the specification in the specification information 131, and updates and centrally manages the mapping relationship information 135. Through this step S104, human review is performed to verify whether there are missing or inconsistent requirements in the specification, and ambiguity corrections input via the input unit 110 result in completed mapping relationship information 135.

In step S105, the route information generation unit 145 refers to the conditional branching structure information 134, expands the conditional branching structure for each branching pattern, assigns a unique route ID to each route, and records the routes in the processing route information 136. The route information generation unit 145 records, in the processing route information 136, a route path as an order of node transitions and route descriptions such as branching results. By enumerating all routes and performing human review, and by receiving ambiguity corrections input via the input unit 110 to obtain completed processing route information 136, the route information generation unit 145 enables management such that all branches are covered during test case generation.

In step S106, the test case generation unit 146 generates test cases based on the ambiguous expression detection information 133, the conditional branching structure information 134, the mapping relationship information 135, the processing route information 136, the extended specification, and the like stored in the storage unit 130. That is, the test case generation unit 146 generates test case information 137 in which input conditions and expected outputs are determined based on the completed mapping relationship information 135 and the processing route information 136.

In addition, the test case generation unit 146 stores the generated test cases in the test case information 137. Furthermore, the test case generation unit 146 performs screen display via the output unit 120, output to an external file via the network 3, and cooperation with other systems by using the test case information 137 and the like.

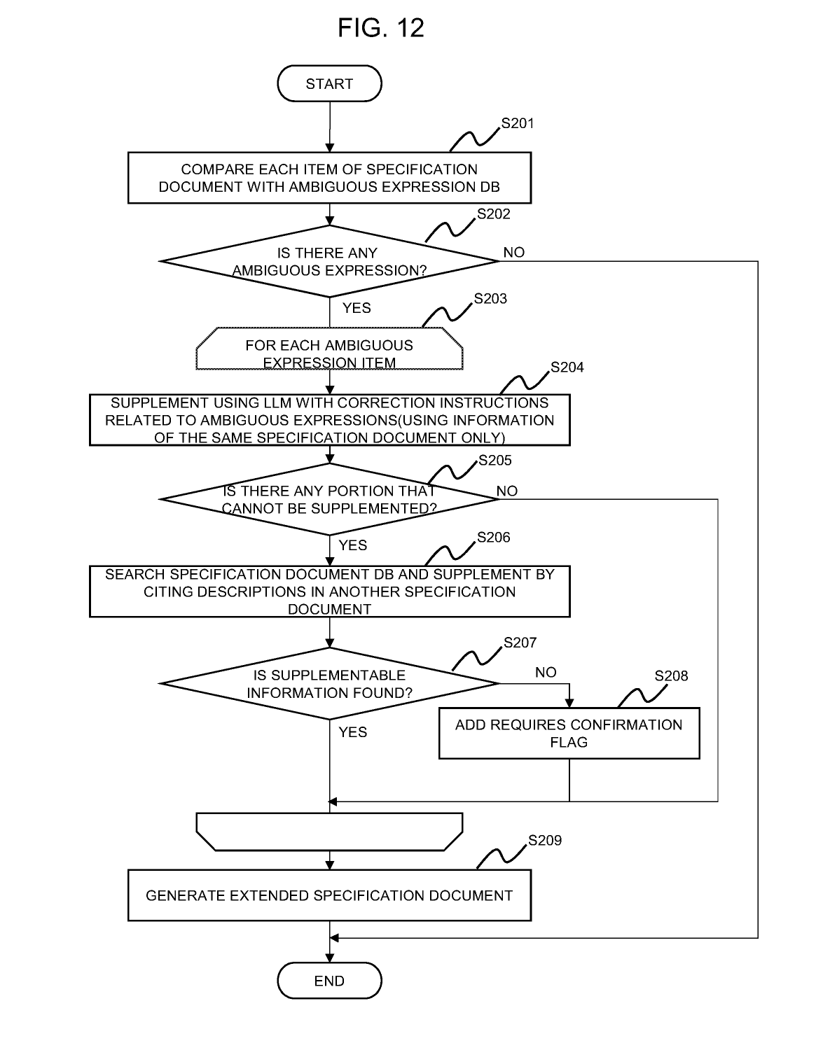

FIG. 12 is a flowchart illustrating an example of detecting and supplementing ambiguous portions (step S102) in the specification extension unit 142 of the test case generation apparatus 100 illustrated in FIG. 11. An outline of processing in each step (S201 to S209) is as follows.

First, in step S201, the specification extension unit 142 refers to the specification information 131 and sequentially scans wordings of respective items described in the specification (design document). Then, the specification extension unit 142 checks whether each item corresponds to an ambiguous expression or term registered in the ambiguous expression knowledge database 132, and automatically extracts candidates of ambiguous words or expressions in the specification.

In step S202, the specification extension unit 142 determines whether an item corresponding to an ambiguous expression is detected as a result of the checking. When the specification extension unit 142 determines that no ambiguous expression is present (No), the processing ends without performing correction of ambiguous expressions. When the specification extension unit 142 determines that an ambiguous expression is present (Yes), the processing proceeds to step S203.

In step S203, the specification extension unit 142 starts a loop for individually performing correction and supplementation processing for each detected ambiguous expression item. The specification extension unit 142 takes up each ambiguous expression one by one and repeats processing in subsequent steps S204 to S208.

In step S204, the specification extension unit 142 inputs correction instructions related to an ambiguous expression and instructs the LLM to perform supplementation processing. Specifically, the specification extension unit 142 refers to an ambiguity correction policy such as a correction method indicated in the field 132C of the ambiguous expression knowledge database 132. Then, the specification extension unit 142 provides, to the LLM (large language model), a correction instruction corresponding to each ambiguous expression and an entire specification written in natural language, and obtains a corrected expression for the ambiguous expression. In this manner, since the LLM performs correction and supplementation processing individually for each ambiguous expression item, an increase in an amount of input data and a decrease in inference capability may be avoided. In addition, the specification extension unit 142 may provide the specification information 131 to the LLM.

The specification extension unit 142 supplements a corrected expression into the corrected field 133F of the ambiguous expression detection information 133 by using information present in the same specification, and replaces or updates a status in the field 133D to “completion of supplementation”. In this manner, the specification extension unit 142 supplements the corrected expression into the corrected field 133F for an ambiguous expression portion identified by a paragraph ID in the field 133B, and stores the ambiguous expression detection information 133.

In step S205, the specification extension unit 142 determines, based on the status in the field 133D, whether there is a portion for which ambiguous expressions cannot be sufficiently corrected using information of the same specification or for which supplementary information cannot be found. When the specification extension unit 142 determines that all ambiguous expressions are corrected or supplemented (No), the processing proceeds to step S209. When the specification extension unit 142 determines that there is a portion that cannot be supplemented (Yes), the processing proceeds to step S206.

In step S206, processing is performed when the specification extension unit 142 determines that sufficient supplementary information cannot be obtained from the same specification. The specification extension unit 142 further searches, in a specification database of the development environment 1, for a similar specification that is similar to the target specification to a certain extent (such as a related document including a description of a specification name of the target specification, another specification, or a manual). Then, the specification extension unit 142 refers to definitions and descriptive texts present in an entire similar specification. The specification extension unit 142 cites information of contents that are described in detail in the similar specification and obtains information for supplementing the ambiguous expression, for example, information having a certain degree of language similarity obtained by vectorization or the like. The information for supplementing the ambiguous expression may be obtained by using the LLM.

In step S207, the specification extension unit 142 determines whether information for supplementing the ambiguous expression is found as a result of the search in step S206. When the specification extension unit 142 determines that information for supplementation is not found (No), the processing proceeds to step S208. When the specification extension unit 142 determines that information for supplementation is found (Yes), the specification extension unit 142 updates the ambiguous expression detection information 133 by using the information for supplementation. Specifically, the specification extension unit 142 stores the information for supplementation as a corrected expression in the corrected field 133F of the ambiguous expression detection information 133, updates the status in the field 133D, and proceeds to step S209.

In step S208, when the specification extension unit 142 determines that information for supplementation is not found, a “confirmation required” flag is assigned to a portion that cannot be supplemented even by referring to a similar specification. That is, the specification extension unit 142 does not supplement the corrected field 133F of the ambiguous expression detection information 133 and sets the field 133F to “Null”, and stores the ambiguous expression detection information 133 with a “confirmation required” flag assigned to the status in the field 133D.

In step S209, when a “confirmation required” flag is assigned to the ambiguous expression detection information 133, the specification extension unit 142 explicitly indicates on a screen that human confirmation by a development engineer is required and prompts a user for additional confirmation. Based on the additional confirmation by the user, the specification extension unit 142 changes the status in the field 133D of the ambiguous expression detection information 133 to a “confirmed” label, and correction and supplementation processing for all ambiguous expressions is completed.

Then, in step S209, the specification extension unit 142 generates an extended specification that reflects update contents of ambiguous expression portions based on information of the extended specification after correction stored in the field 133F of the ambiguous expression detection information 133, and ends the processing.

For example, as shown in a first-row record of the ambiguous expression detection information 133 in FIG. 5, an original specification description “1.2.1.1.2 in other cases” stored in the field 133E becomes a corrected specification description “1.2.1.1.2 when a determination result is false (FALSE)” stored in the field 133F. Accordingly, a description “1.2.1.1.2 in other cases” in a predetermined specification (original text) is changed to “1.2.1.1.2 when a determination result is false (FALSE)” in the extended specification (after correction).

In this manner, the specification extension unit 142 refers to information of defined terms and context in an entire same specification or a similar specification, generates an extended specification obtained by supplementing the predetermined specification, and resolves ambiguity.

Thereafter, since the conditional branching structure generation (step S103), the test case generation processing (step S106), and the like in FIG. 11 are analyzed based on the extended specification, high-accuracy processing may be performed in a state in which ambiguous expressions are reduced.

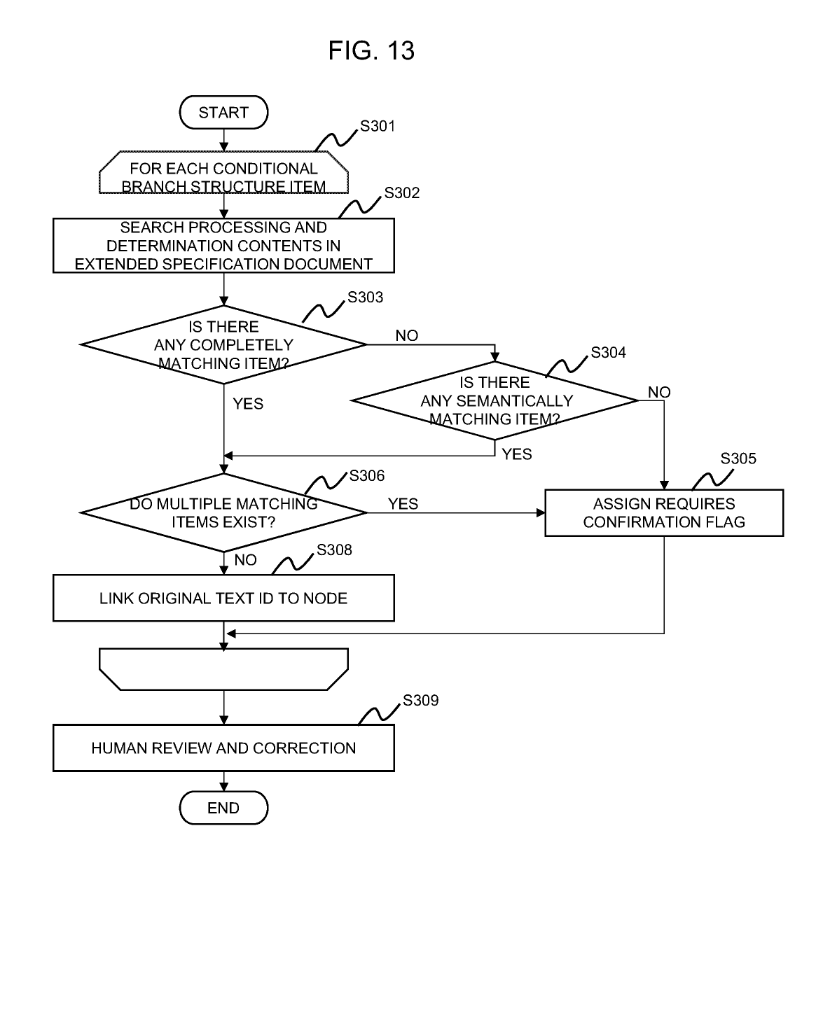

FIG. 13 is a flowchart illustrating an example of a processing flow of mapping between a conditional branching structure and a specification (step S104) in the mapping relationship generation unit 144 of the test case generation apparatus 100 illustrated in FIG. 11. An outline of processing in each step (S301 to S309) is described below.

In step S301, when mapping processing between the conditional branching structure and the extended specification is started, the mapping relationship generation unit 144 sequentially extracts nodes having node IDs that constitute node types of “processing” and “determination” for each record item of the conditional branching structure information 134. That is, the mapping relationship generation unit 144 targets all nodes (record items) regardless of whether a node type is “processing” or “determination”.

In step S302, the mapping relationship generation unit 144 refers to a current node and the extended specification (specification information in which ambiguous expressions are corrected or supplemented). The mapping relationship generation unit 144 identifies a paragraph or an expression description in the specification corresponding to processing contents stored in the field 134E that are executed by a node of the node type “processing” in the conditional branching structure information 134. Then, the mapping relationship generation unit 144 searches for a degree of matching indicating whether the paragraph or the expression description in the specification completely matches or semantically matches a paragraph or an expression description in the extended specification.

In addition, the mapping relationship generation unit 144 identifies a paragraph or an expression description in the specification corresponding to a conditional expression (determination condition) stored in the field 134D that is executed by a node of the node type “determination” in the conditional branching structure information 134. Then, the mapping relationship generation unit 144 searches for a degree of matching indicating whether the paragraph or the expression description in the specification completely matches or semantically matches a paragraph or an expression description in the extended specification. That is, the mapping relationship generation unit 144 searches for and identifies which description item in the extended specification serves as a basis for the node.

In step S303, the mapping relationship generation unit 144 determines whether a description of a node type (processing or determination) identified as a search result completely matches a description in the specification. When a completely matching description exists (Yes), the mapping relationship generation unit 144 proceeds to step S306. When no completely matching description exists (No), the mapping relationship generation unit 144 proceeds to step S304 and determines semantic matching or partial matching.

Step S304 is performed because, even when wordings do not completely match, substantially the same meaning may be present by synonymous expressions or a combination of a plurality of paragraphs. That is, this step determines whether an item that may be regarded as semantically matching exists.

In step S304, when a semantically matching description exists (Yes), the mapping relationship generation unit 144 may determine that the description corresponds to the same requirement in terms of meaning even if there is a typographical error or a variation in expression, and proceeds to step S306. When no semantically matching description exists in step S304 (No), the mapping relationship generation unit 144 proceeds to step S305.

In step S305, when neither a completely matching description nor a semantically matching description exists, the mapping relationship generation unit 144 assigns a “confirmation required” flag to the mapping relationship information 135. When neither complete matching nor semantic matching is found and a description in the specification cannot be associated with a description in the extended specification, there is a possibility that a corresponding portion does not exist in the specification or that the description is insufficient or missing. Therefore, in step S305, a “confirmation required” flag is assigned to the mapping relationship information 135 to enable supplementation or correction in a subsequent process or by a responsible person.

In step S306, the mapping relationship generation unit 144 determines whether a plurality of matching items exists. When a plurality of matching items exists (Yes), it becomes difficult to identify which paragraph is correct as a basis. Therefore, further examination or selection is required, and the mapping relationship generation unit 144 proceeds to step S305 and assigns a “confirmation required” flag to the mapping relationship information 135. When no plurality of candidates exists in step S306 and a single candidate exists (No), the mapping relationship generation unit 144 proceeds to step S308.

In step S308, when the mapping relationship generation unit 144 can clearly identify that there is exactly one matching item, the mapping relationship generation unit 144 stores a node ID in the field 135B of the mapping relationship information 135 and stores a paragraph ID in the extended specification in the field 135C in a linked manner. In addition, the mapping relationship generation unit 144 stores, as a mapping type in the field 135D, a degree of matching between a description in the specification and a description in the extended specification. In this manner, the mapping relationship information 135 is visualized via the output unit 120 so that which node is based on which description item in the extended specification and to what extent can be traced.

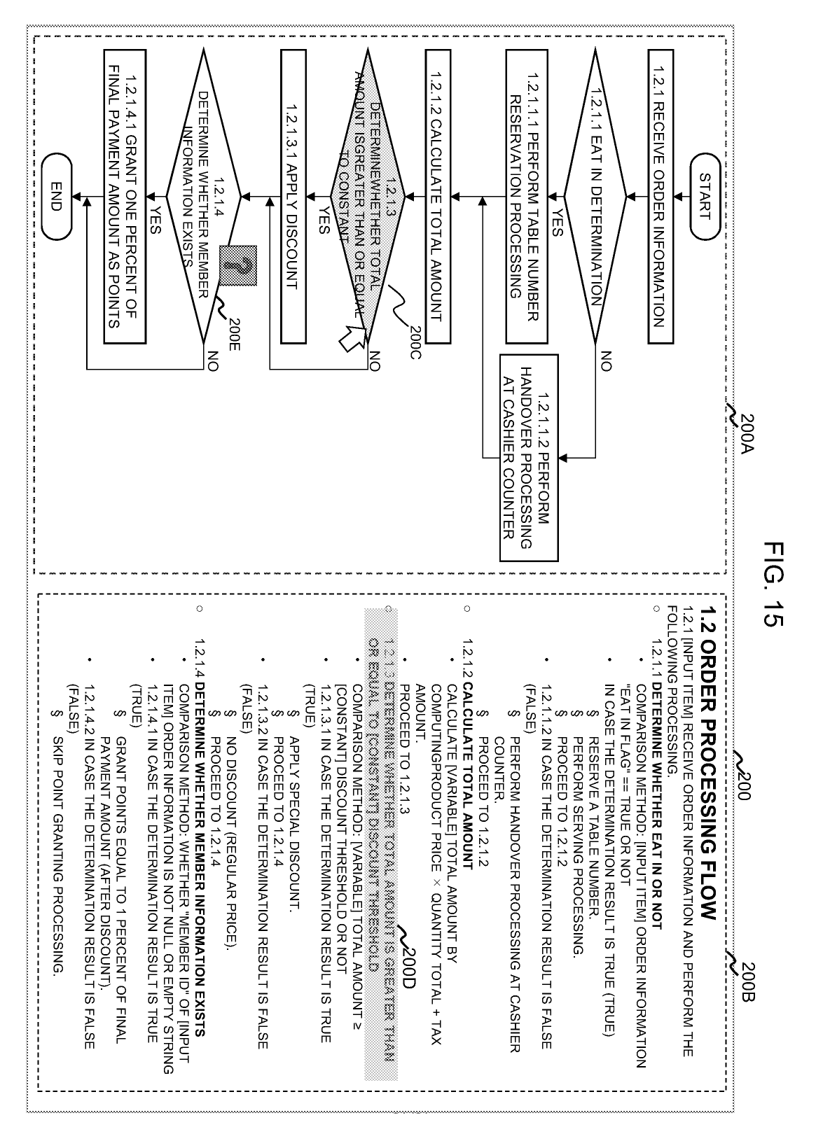

In step S309, which is a final step of the processing, the mapping relationship generation unit 144 displays, via the output unit 120, items to which a “confirmation required” flag is assigned and results of linking in the mapping relationship information 135 by referring to the conditional branching structure information 134 and the like (see FIG. 15). Through this visualization, human reviewers or developers perform review, and the mapping relationship generation unit 144 corrects the mapping relationship information 135 and the like based on correction information input via the input unit 110 as necessary.

As a result, the mapping relationship information 135 is finalized, and correspondence between the specification and the conditional branching structure is completed. Thereafter, the test case generation apparatus 100 performs assignment of all route IDs to the conditional branching structure and confirmation of coverage (step S105) illustrated in FIG. 11.

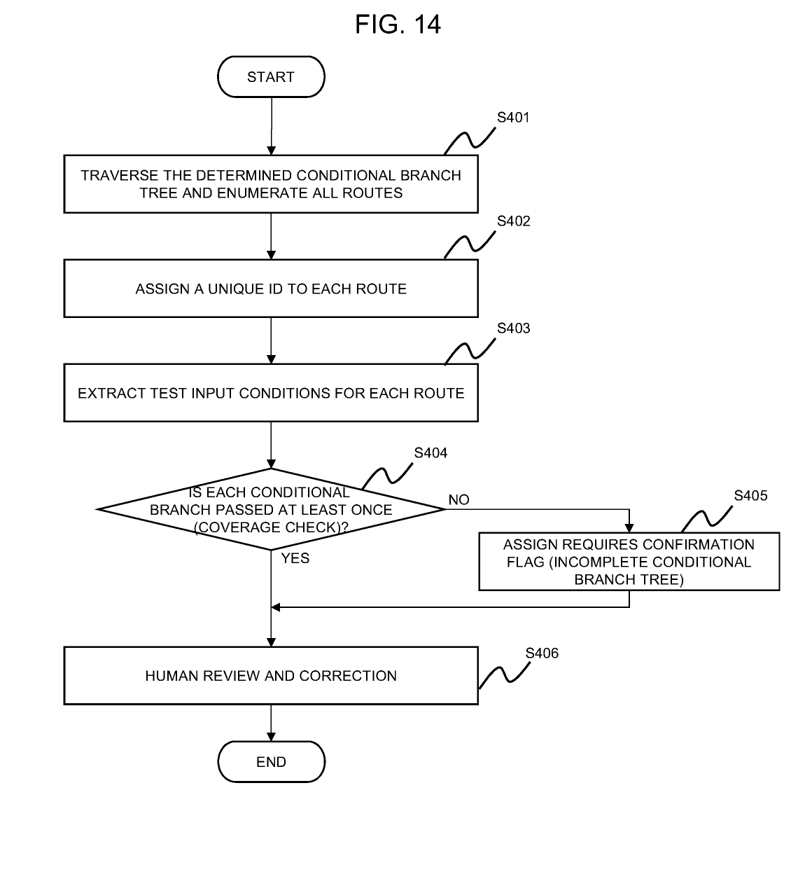

FIG. 14 is a flowchart illustrating an example of processing of assigning all route IDs to a conditional branching structure and confirming coverage (step S105) in the route information generation unit 145 of the test case generation apparatus 100 illustrated in FIG. 11. An outline of processing in each step (S401 to S407) is described below.

In step S401, when route traversal processing of the conditional branching structure is started, the route information generation unit 145 traverses all paths (combinations of traversed nodes) on a tree based on the finalized conditional branching structure information 134. Then, the route information generation unit 145 expands the conditional branching structure into all branching patterns and enumerates all possible routes. As a result, the route information generation unit 145 comprehensively lists execution routes based on combinations of branching conditions such as “True” and “False”.

Next, in step S402, the route information generation unit 145 assigns a unique route ID to each enumerated route and stores the route ID in the processing route information 136. For example, the route information generation unit 145 stores route IDs in a format such as “CR001” and “CR002” in the field 136A of the processing route information 136. Then, the processing route information 136 stores, in the field 136B, a processing order of node IDs including branching patterns as a route path.

In step S403, the route information generation unit 145 extracts and stores a route description such as input data and preconditions (for example, flag values and parameter ranges) required when each route is taken. This information is also used as an input pattern in a subsequent test case generation process.

In step S404, the route information generation unit 145 determines, for all routes, whether each branch on the tree is traversed at least once. That is, the route information generation unit 145 determines whether a node whose node type in the field 134C of the conditional branching structure information 134 is “determination” and whose node ID is stored in the field 134A is traversed at least once. In addition, when a branch is not traversed even once and branching processing is not performed, the route information generation unit 145 determines that there is an option that cannot reach the conditional branching structure and that the conditional branching structure cannot be expanded into branching patterns.

In step S405, when the determination result in step S404 indicates that there is an untraversed branch or that some branches are not covered (No), the route information generation unit 145 assigns a “confirmation required” flag to the processing route information 136 as an incomplete conditional branching structure. The “confirmation required” flag indicates that review of the specification or recreation of routes is required.

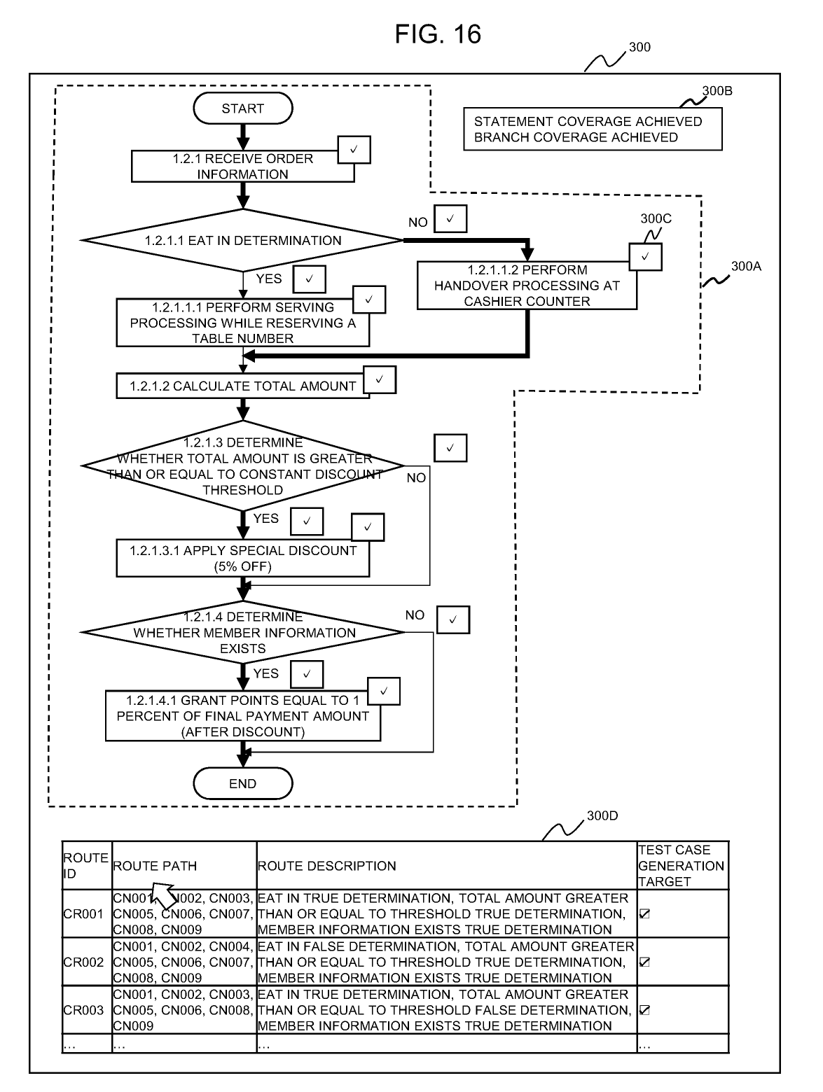

In step S406, the route information generation unit 145 displays, via the output unit 120, a prompt for review to a person in charge or a developer (see FIG. 16). When a “confirmation required” flag is assigned, or when ambiguous points such as an incomplete route path occur because ambiguity is not corrected during route enumeration, the person in charge or the developer performs manual correction or additional input via the input unit 110 in accordance with the screen display. Then, the route information generation unit 145 supplements missing routes or corrects conditional expressions, changes the test case generation target in the field 136D of the processing route information 136 to “True”, and obtains completed processing route information 136 in which ambiguity is corrected.

In this manner, the route information generation unit 145 completes a route path configuration that covers all conditional branching structures, stores the route path configuration in the processing route information 136, and ends the processing. Thereafter, the test case generation apparatus 100 proceeds to generate test cases from the conditional branching routes illustrated in FIG. 11 (step S106).

FIG. 15 is a screen illustrating an example of a GUI (Graphical User Interface) for performing mapping work between a conditional branching structure and paragraphs of a specification in human review and correction (step S309) in the mapping relationship generation unit 144 of the test case generation apparatus 100 illustrated in FIG. 13.

In FIG. 15, the conditional branching structure information 134 is displayed based on information such as the mapping relationship information 135. In a screen 200 of FIG. 15, a flowchart area 200A on a left side visually displays a flowchart-format conditional branching structure based on the conditional branching structure information 134, and a text area 200B on a right side displays text information of the extended specification.

Hereinafter, screen elements and usage thereof are described. In the flowchart area 200A, processing contents of order processing are displayed in a flowchart. In the flowchart area 200A, for example, nodes such as “1.2.1 order information reception” and “1.2.1.2 calculation of total amount” are displayed as processing symbols. In addition, nodes such as “1.2.1.1 dine-in determination”, “1.2.1.3 determination of whether a total amount is equal to or greater than a [constant] discount threshold”, and “1.2.1.4 determination of presence or absence of member information” are displayed as branching symbols. Branches of the branching symbols are visualized as routes labeled “Yes” and “No”. In this manner, a user may overview and confirm a processing flow by a flowchart display.

In the text area 200B, the specification is displayed for each corresponding section or paragraph. In the text area 200B, for example, detailed text information such as “1.2.1 [Input Item] Receive order information and perform the following processing.”, “1.2.1.1 determination of whether dine-in; comparison method: [Input Item] whether ‘dine-in flag’ of order information == TRUE”, and “1.2.1.3 determination of whether a total amount is equal to or greater than a [constant] discount threshold; comparison method: [Variable] total amount ≥ [constant] discount threshold” is described.

A processing number included in a processing or branching symbol in the flowchart area 200A, such as “1.2.1.3”, is associated with a paragraph number included in text information in the text area 200B, such as “1.2.1.3”.

A user places an indicator such as a cursor on a node having the processing number “1.2.1.3” in the flowchart area 200A (mouse-over). By this placement, the mapping relationship generation unit 144 highlights the branching symbol 200C, and at the same time highlights, as a reference element, text information of a corresponding paragraph 200D in the text area 200B.

In this manner, since nodes of the conditional branching structure in the flowchart area 200A are linked with text information in the text area 200B, when the user performs mouse-over or clicking, the branching symbol 200C that is mouse-overed and related text information are highlighted. Accordingly, the user may easily confirm which processing is based on which portion of the specification.

On the other hand, for a node having the processing number “1.2.1.4” in the flowchart area 200A, a confirmation-required symbol 200E “?” is displayed on or near the node based on a “confirmation required” flag in the conditional branching structure information 134. The confirmation-required symbol 200Eindicates that a paragraph in the text area 200B corresponding to the processing number “1.2.1.4” is ambiguous or requires confirmation. In this manner, the user may prevent overlooking points to be associated.

When reviewing an order processing flow, the user checks the flowchart in the flowchart area 200A from top to bottom to confirm determination conditions (Yes/No) and subsequent processing at each step. For example, at a branching node “1.2.1.1 dine-in determination”, when proceeding to “Yes”, the user may confirm that processing “1.2.1.1.1 perform serving processing to secure a table number” is performed.

When a user performs mouse-over (selection) on a specific node on the flowchart in the flowchart area 200A, a corresponding paragraph in the text area 200B is automatically highlighted. Accordingly, the user may immediately grasp where the processing is described in the specification and which paragraph serves as a basis.

When there is a portion for which correspondence between the flowchart in the flowchart area 200A and the text information of the specification in the text area 200B is unclear or a portion for which description is insufficient, the test case generation apparatus 100 displays an icon or a label on the screen. The user may click a confirmation-required item indicated by a “?” symbol and input supplementary information or add contents of a referenced similar specification. Input or addition may be performed via a pop-up editor screen displayed on the screen.

In this manner, since a paragraph serving as a basis between the flowchart in the flowchart area 200A and the text information of the specification in the text area 200B may be confirmed on the same screen, the user may easily verify consistency between requirements and processing logic. In addition, with assistance such as mouse operations and highlighting functions, the user may intuitively confirm association between nodes and specification paragraphs. Accordingly, a burden on the user to scroll-search a relevant portion in the specification is significantly reduced, and the user may quickly access a portion corresponding to a confirmation-required item in the flowchart area 200A.

FIG. 16 illustrates an example of a GUI for performing coverage confirmation processing in human review and correction (step S406) in the route information generation unit 145 of the test case generation apparatus 100 illustrated in FIG. 14.

An entire screen 300 in FIG. 16 includes elements displayed by the route information generation unit 145, including a flowchart area 300A displayed on an upper left side, coverage information 300B displayed on an upper right side, and a route list table 300D displayed on a lower side. In addition, a check mark 300C is attached to each node of the flowchart in the flowchart area 300A.

Each screen element and usage thereof will be described. For example, the flowchart area 300A displays processing contents of order processing in a flowchart format. In the flowchart area 300A, nodes corresponding to processing steps such as “1.2.1 order information reception”, “1.2.1.1 dine-in determination”, “1.2.1.2 calculation of total amount”, “1.2.1.3 determination of whether a total amount is equal to or greater than a predetermined amount”, and “1.2.1.4 determination of presence or absence of member information” are displayed. Branch routes in processing steps represented by branching symbols are visualized as routes labeled “Yes” and “No”. In this manner, a user may overview and confirm a processing flow by a flowchart display.

Check marks 300C attached to processing steps and branch routes in the flowchart area 300A based on the conditional branching structure information 134 indicate that the processing steps and branch routes are expandable and are targets for test case generation. Processing steps and branch routes without the check marks 300C indicate that expansion is not possible and test cases have not been generated.

In this manner, the check marks 300C are displayed on or near nodes and branch lines (branch routes) in the flowchart, and display of the check marks 300C indicates that test cases have been generated and that the processing steps and branch routes are “covered by test cases”.

Accordingly, the route information generation unit 145 may visualize steps and branches covered by testing by linking the flowchart in the flowchart area 300A with the check marks 300C. For example, while viewing each step displayed in the flowchart area 300A, a user may grasp at a glance which branches are targets for test case generation and which branches are excluded or under confirmation.

When a user places an indicator such as a cursor on a check mark 300C(mouse-over or clicking), the route information generation unit 145 highlights a processing path in the flowchart area 300A that is covered by a corresponding test case. At this time, the route information generation unit 145 displays, in a pop-up manner, detailed information such as a test case ID, a corresponding paragraph of the specification, and contents of the processing route information 136. The flowchart and route information in the flowchart area 300A are linked with paragraph IDs serving as a basis in the extended specification, thereby allowing the user to confirm which processing originates from which specification.

When a user places an indicator such as a cursor on a node or a branch line without a check mark 300C (mouse-over or clicking), the route information generation unit 145 displays, in a pop-up manner, contents such as a confirmation-required flag in the processing route information 136 indicating that the test case has not been generated. In this manner, when a question arises, a user (such as a developer or a test engineer) may easily refer to a corresponding portion of the specification through a simple cursor operation (for example, a single click), thereby facilitating verification of ambiguous expressions or confirmation-required items in the specification.

The coverage information 300B displays wording such as “statement coverage achieved” and “branch coverage achieved”. The coverage information 300B indicates a current progress status of test case generation or route confirmation, and the progress status is indicated by display of “achieved” or “not achieved”. “Statement coverage achieved” indicates that each node represented by a processing symbol has been passed. “Branch coverage achieved” indicates that each branch route represented by a branching symbol has been passed. When “statement coverage” or “branch coverage” is displayed as “achieved”, this indicates that a coverage target of the order processing flow has been achieved. By checking statuses of “statement coverage” and “branch coverage” in the coverage information 300B, a degree of achieved coverage may be quickly determined.

In the route list table 300D, a route ID such as “CR001”, “CR002”, or “CR003”, a specific route path (a list of nodes passed), a brief route description, and presence or absence of a test case target are displayed based on the processing route information 136. For example, “CR001” represents a route including a dine-in True determination, a total-amount-threshold-or-higher True determination, and a member-information-present True determination, and the user may confirm in a list that the route has already been designated as a test case generation target.

A user places an indicator such as a cursor on a route path in the route list table 300D (mouse-over or clicking). Upon such placement, the route information generation unit 145 displays contents of processing and a breakdown of branch results belonging to the route, thereby allowing the user to confirm the contents.

In addition, when a user places an indicator such as a cursor on each route ID (such as “CR001” or “CR002”) in the route list table 300D (mouse-over or clicking selection), the route information generation unit 145 highlights or emphasizes a corresponding path on the flowchart in the flowchart area 300A. Accordingly, the user may intuitively grasp which nodes are actually passed by a route corresponding to the selected route ID.

A user may, at the user’s discretion, remove a check indicating a test case generation target in the route list table 300D, and the route information generation unit 145 may modify the processing route information 136 and set a route for which the check has been removed to be excluded from test case generation targets.

In this manner, the route list table 300D lists all branching patterns (route paths), and enables centralized management of route overviews and test execution statuses by displaying route descriptions and test case generation target indications.

As described above, the test case generation apparatus 100 automatically detects and corrects ambiguities in a specification, generates a conditional branching structure, and easily generates test cases covering all branches. The test case generation apparatus 100 refers to an ambiguous expression knowledge database and detects ambiguous expressions, and at the same time supplements and corrects the specification using information in the same specification or information in similar specifications. In this manner, the test case generation apparatus 100 significantly reduces manual work for searching ambiguous portions and correcting descriptions, and improves overall quality of the specification.

In addition, the test case generation apparatus 100 automatically generates a conditional branching structure (tree) based on a specification in which ambiguous expressions have been resolved, and visualizes processing logic. Furthermore, the test case generation apparatus 100 enumerates and manages all branching patterns and assigns IDs to route information, thereby allowing a user (such as a developer or a tester) to prevent omission of execution routes and reliably prepare highly comprehensive test cases. By generating mapping information that associates each node of the conditional branching structure with a paragraph of the extended specification, the test case generation apparatus 100 may centrally manage consistency between requirements and implementation logic. In this manner, the user may track which paragraph serves as a basis for which node, thereby facilitating early detection of requirement omissions or inconsistencies.

A GUI screen provided by the test case generation apparatus 100 is capable of simultaneously displaying nodes of a processing flow and paragraphs of a specification of a conditional branching structure, thereby allowing a user to intuitively grasp ambiguous portions or routes for which testing has not been performed. The user may refer to highlighted confirmation-required symbols or check marks, easily identify portions to be corrected, and improve efficiency of review and correction. By achieving branch coverage, the user may reduce quality risks caused by insufficient testing.

### Embodiment 2

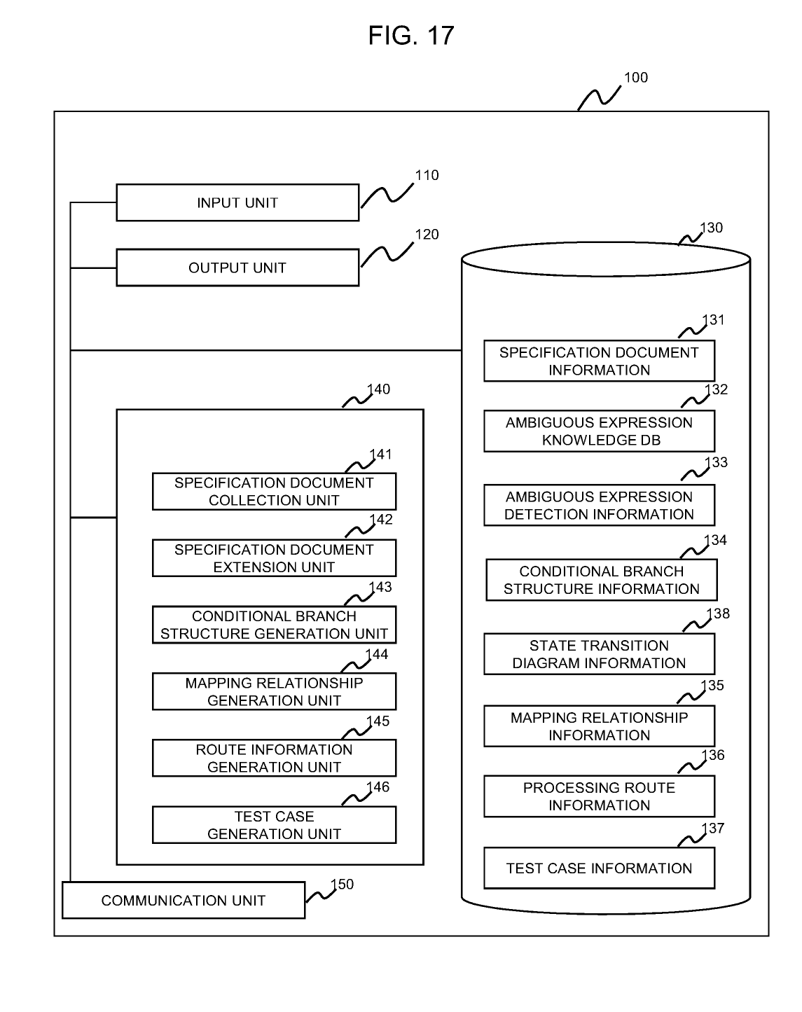

FIG. 17 is another functional block diagram illustrating an example of a functional configuration of the test case generation apparatus 100. This embodiment corresponds to a modification of Embodiment 1. Therefore, differences from Embodiment 1 will be mainly described below. In this embodiment, extended specification information is obtained from a specification described in natural language in the same manner as in Embodiment 1, and this embodiment differs from Embodiment 1 in that conditional branching structure information 134 and state transition diagram information 138 are used.

The state transition diagram information 138 is information of a model formed as a state machine when grasping an overall flow of a system on a state-based basis. The state transition diagram information 138 defines system states, events that cause transitions between the states, guard conditions, and the like.

Specifically, the conditional branching structure information 134 and the state transition diagram information 138 will be described using, as an example, an order processing system for ordering products. This embodiment aims to organize complex specifications by using the conditional branching structure information 134 and the state transition diagram information 138 in combination.

In the order processing, a state transitions from “INIT (initial state)” to “ORDERED (order placed)”, and an event “placeOrder” and a guard condition “whether an inventory quantity is greater than zero” are involved. When inventory does not exist, the state transitions to an error state. In this manner, the order processing involves state transitions caused by multiple conditional branches. This guard condition refers to a node ID to which a node type “determination” is assigned in the previously extracted conditional branching structure information 134, thereby maintaining consistency using the same conditional expression.

That is, in a model of the state transition diagram information 138 on a state machine side, by using the same node ID for a conditional expression of a node type “determination” set on a conditional branching structure information 134 side and a guard condition used on the state machine side, duplicated descriptions and inconsistencies may be prevented while maintaining the model. Note that the conditional branching structure information 134 itself is effective when it is desired to trace details of a specific processing flow as in Embodiment 1.

The conditional branching structure information 134 manages, for each IF–THEN–ELSE branch of a conditional expression, a “processing destination in a True case” and a “processing destination in a False case” as relationships between nodes using child node IDs. The conditional branching structure information 134 is capable of visualizing a series of control flows (for example, an order processing flow).

In this embodiment, a node ID of the state transition diagram information 138 and a node ID of the conditional branching structure information 134 are the same node ID, and the node ID is used to refer to guard conditions and processing contents in the state transition diagram information 138. In this manner, by using the conditional branching structure and the state transition diagram in combination, complex specifications may be easily organized.

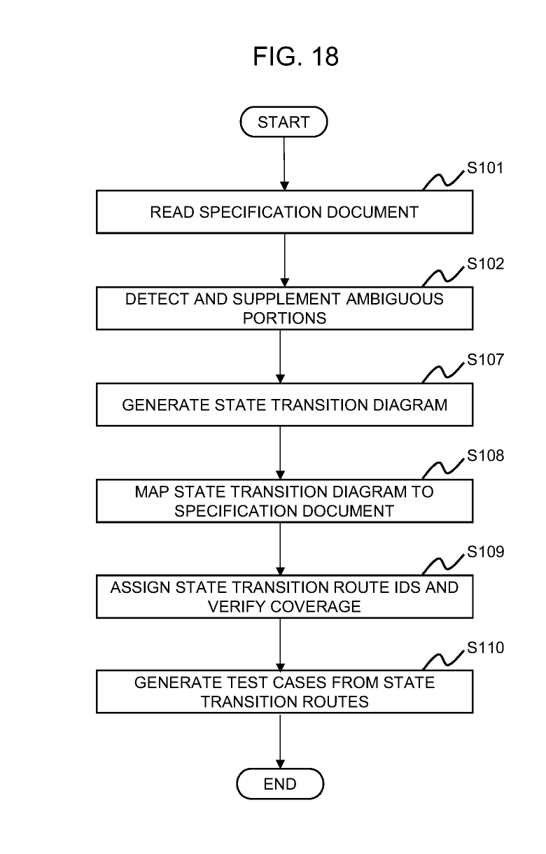

FIG. 18 is a flowchart illustrating an example of an overall processing flow of test case generation by the test case generation apparatus 100 according to an embodiment of the present invention. An outline of processing in each step (steps S101 to S110) will be described below.

In step S101, when test case generation processing is started, the specification collection unit 141 of the test case generation apparatus 100 reads specifications (design documents and related documents) obtained from the development environment 1 via the input unit 110, the communication unit 150, or the like. Then, data such as specification information required in subsequent processes are extracted and stored in the specification information 131 in the storage unit 130 of the test case generation apparatus 100.

In step S102, the specification extension unit 142 refers to the specification information 131 and the ambiguous expression knowledge database 132, analyzes contents of the specification, and detects ambiguous descriptions or items with omissions. The specification extension unit 142 performs, as necessary, corrections such as addition of supplementary information or clarification of conditional expressions, and updates the ambiguous expression detection information 133 in a form in which ambiguity is resolved. Through this step, specification data that is easy to interpret in subsequent processes such as a branching structure generation process is obtained.

In step S107, the conditional branching structure generation unit 143 extracts processing contents and conditional expressions from the ambiguous expression detection information 133 of the corrected and extended specification information, and organizes and stores the extracted information as conditional branching structure information 134 representing a conditional branching structure. Specifically, the conditional branching structure generation unit 143 structures node types such as “processing” and “determination” in a tree format and clarifies respective branching conditions.

In addition, in step S107, the conditional branching structure generation unit 143 extracts system states, events that cause state changes, guard conditions, processing contents, node IDs, and the like from the ambiguous expression detection information 133, the conditional branching structure information 134, and the like. Then, the conditional branching structure generation unit 143 organizes and stores the extracted information as state transition diagram information 138 representing a state transition diagram. As a result, comprehensive scenario examination becomes possible in subsequent test case generation.

In step S108, the mapping relationship generation unit 144 presents to a user correspondence between the state transition diagram information 138 representing the generated state transition diagram and each paragraph or functional requirement of the specification. The mapping relationship generation unit 144 creates or updates mapping relationship information 135 indicating on which paragraph (requirement) each node (processing or determination) is based, and centrally manages the correspondence. Through this step, it becomes easier to verify whether there are omissions or inconsistencies in specification requirements.

In step S109, the route information generation unit 145 refers to the state transition diagram information 138, expands the state transition diagram for all branching patterns, and assigns a unique state transition route ID to each route. The route information generation unit 145 records, in the processing route information 136, a route path representing an order of node transitions and a route description such as branching results. By enumerating all routes, the route information generation unit 145 is able to manage routes so that all branches are covered during test case generation.

Finally, in step S110, the test case generation unit 146 generates test cases in which input conditions and expected outputs are determined based on state transition routes derived from the established and stored specification information 131, the state transition diagram information 138, the processing route information 136, and the like. The test case generation unit 146 stores the generated test cases in the test case information 137. In addition, the test case generation unit 146 performs screen display via the output unit 120, output to an external file via the network 3, and cooperation with other systems using the test case information 137 and the like.

In this manner, the test case generation apparatus 100 according to Embodiment 2 is able to mitigate problems such as misinterpretation and excessive input token counts that occur when a large specification written in natural language is directly input to an LLM as in conventional approaches. In the test case generation apparatus 100 according to Embodiment 2, the state transition diagram information 138 is structured in advance using conditional expressions and a state transition model of the specification, and only necessary portions are provided to the LLM in a stepwise manner, thereby mitigating such problems.

Specifically, since the state transition diagram information 138 centrally manages logical conditions from which ambiguous expressions and redundant descriptions have been eliminated and assigns IDs thereto, the LLM is able to more easily analyze conditional branching and state transitions in a machine-readable format. As a result, test case generation and detection of specification inconsistencies may be performed accurately and at high speed.

In this manner, the test case generation apparatus 100 according to Embodiment 2 is effective in domains in which a large number of complex and interdependent flows exist. In addition, the test case generation apparatus 100 is capable of using both the conditional branching structure information 134 and the state transition diagram information 138 together. The test case generation apparatus 100 may grasp individual control logic in a consistent format using common IDs and may form a basis for extraction of test patterns by an LLM.

In this manner, the test case generation apparatus 100 models a specification by combining the conditional branching structure information 134 and the state transition diagram information 138, and maintains consistency through IDs assigned to respective conditions. The test case generation apparatus 100 realizes a structure that is easier for an LLM to process than a conventional specification centered on natural language, thereby contributing to reduction of review effort and improvement of review quality. As a result, the test case generation apparatus 100 contributes to reduction of test effort and improvement of test quality.

Although the present embodiment has been described above, the present embodiment discloses at least the following configurations.

(1) A test case generation apparatus that generates a test case from a specification written in natural language, the test case generation apparatus comprising:
a specification collection unit configured to extract specification information related to system development from the specification;
a specification extension unit configured to generate ambiguous expression detection information including an ambiguous expression of the specification and a corrected expression, based on the specification information and an ambiguous expression knowledge database, and to generate an extended specification by supplementing the ambiguous expression included in the ambiguous expression detection information using the specification or a similar specification having a predetermined degree of similarity to the specification;
a conditional branching structure generation unit configured to generate conditional branching structure information in which a conditional branching structure is constructed from the ambiguous expression detection information;
a mapping relationship generation unit configured to generate mapping relationship information that associates a description of the specification and a description of the extended specification with node information relating to a node type extracted from the conditional branching structure information;
a route information generation unit configured to scan the conditional branching structure information, expand the conditional branching structure into branching patterns, and generate processing route information in which a route ID is assigned to each branching pattern; and
a test case generation unit configured to generate test case information including an input condition and an expected output based on completed mapping relationship information and the processing route information.

(2) The test case generation apparatus described in (1), wherein the specification extension unit supplements the ambiguous expression using a large language model based on overall information of the specification to generate the extended specification.

(3) The test case generation apparatus described in (1), wherein the specification extension unit generates the ambiguous expression detection information in which a corrected expression for the ambiguous expression is supplemented.

(4) The test case generation apparatus described in (1), wherein the specification extension unit generates the ambiguous expression detection information to which a confirmation-required flag is attached when there is no related information associated with supplementation of the ambiguous expression.

(5) The test case generation apparatus described in (1), wherein the specification extension unit performs a screen display that prompts confirmation when the ambiguous expression detection information to which the confirmation-required flag is attached exists.

(6) The test case generation apparatus described in (1), wherein the mapping relationship information generated by the mapping relationship generation unit includes a mapping type indicating a degree of correspondence between a description of the specification and a description of the extended specification.

(7) The test case generation apparatus described in (1), wherein the mapping relationship generation unit displays, on a screen, a flowchart-type conditional branching structure based on the conditional branching structure information and text information of the extended specification, and highlights a node on which an indicator is placed and text information of the extended specification corresponding to the node when the indicator is placed on a node of the flowchart-type conditional branching structure.

(8) The test case generation apparatus described in (1), wherein the mapping relationship information generated by the mapping relationship generation unit is assigned a confirmation-required flag when a description of the specification and a description of the extended specification cannot be associated.

(9) The test case generation apparatus described in (8), wherein the mapping relationship generation unit displays, on a screen, a flowchart-type conditional branching structure based on the conditional branching structure information and text information of the extended specification, and displays a confirmation-required symbol on or near a node of the flowchart-type conditional branching structure based on the confirmation-required flag assigned to the mapping relationship information.

(10) The test case generation apparatus described in (1), wherein the route information generation unit assigns a confirmation-required flag to the processing route information when a conditional branching structure cannot be expanded into branching patterns.

(11) The test case generation apparatus described in (10), wherein the route information generation unit displays, on a screen, a flowchart-type conditional branching structure based on the conditional branching structure information and a route list table based on the processing route information, displays a check mark on or near a branching pattern that can be expanded in the displayed conditional branching structure, and does not display the check mark on or near a branching pattern that cannot be expanded.

(12) The test case generation apparatus described in (1), wherein a flowchart-type conditional branching structure based on the conditional branching structure information and a route list table based on the processing route information are displayed on a screen, and when an indicator is placed on the route list table, a corresponding path of the flowchart-type conditional branching structure is highlighted.

(13) A test case generation method executed by a computer to generate a test case from a specification written in natural language, the method comprising:
extracting, by a specification collection unit, specification information related to system development from the specification;
detecting, by a specification extension unit, an ambiguous expression of the specification and a corrected expression based on the specification information and an ambiguous expression knowledge database, supplementing the ambiguous expression included in ambiguous expression detection information using the specification or a similar specification having a predetermined degree of similarity to the specification, and generating an extended specification;
generating, by a conditional branching structure generation unit, conditional branching structure information in which a conditional branching structure is constructed from the ambiguous expression detection information;
generating, by a mapping relationship generation unit, mapping relationship information that associates a description of the specification and a description of the extended specification with node information relating to a node type extracted from the conditional branching structure information;
generating, by a route information generation unit, processing route information by scanning the conditional branching structure information, expanding the conditional branching structure into branching patterns, and assigning a route ID to each branching pattern; and
generating, by a test case generation unit, test case information including an input condition and an expected output based on completed mapping relationship information and the processing route information.

The present invention is not limited to the embodiments described above as they are, and in an implementation stage, constituent elements may be modified and embodied within a scope not departing from the gist thereof, or multiple constituent elements disclosed in the embodiments may be appropriately combined for implementation.

What is claimed is:

1. A test case generation apparatus for generating a test case from a specification written in natural language, comprising:
a specification collection unit configured to extract specification information related to system development from the specification;
a specification extension unit configured to generate ambiguous expression detection information including an ambiguous expression of the specification and a corrected expression based on the specification information and an ambiguous expression knowledge database, supplement the ambiguous expression included in the ambiguous expression detection information using the specification or a similar specification having a predetermined degree of similarity to the specification, and generate an extended specification;
a conditional branching structure generation unit configured to generate conditional branching structure information in which a conditional branching structure is constructed from the ambiguous expression detection information;
a mapping relationship generation unit configured to generate mapping relationship information that associates a description of the specification and a description of the extended specification with node information relating to a node type extracted from the conditional branching structure information;
a route information generation unit configured to scan the conditional branching structure information, expand the conditional branching structure into branching patterns, and generate processing route information in which a route ID is assigned to each branching pattern; and
a test case generation unit configured to generate test case information including an input condition and an expected output based on completed mapping relationship information and the processing route information.

2. The test case generation apparatus according to claim 1,
wherein the specification extension unit supplements the ambiguous expression of the specification using a large language model based on overall information of the specification to generate the extended specification.

3. The test case generation apparatus according to claim 1,
wherein the specification extension unit generates the ambiguous expression detection information in which a corrected expression corresponding to the ambiguous expression is supplemented.

4. The test case generation apparatus according to claim 1,
wherein the specification extension unit generates the ambiguous expression detection information to which a confirmation-required flag is assigned when no related information for supplementing the ambiguous expression exists.

5. The test case generation apparatus according to claim 4,
wherein the specification extension unit performs a screen display prompting confirmation when the ambiguous expression detection information to which the confirmation-required flag is assigned exists.

6. The test case generation apparatus according to claim 1,
wherein the mapping relationship information generated by the mapping relationship generation unit includes a mapping type representing a degree of correspondence between the description of the specification and the description of the extended specification.

7. The test case generation apparatus according to claim 1,
wherein the mapping relationship generation unit
displays, on a screen, a flowchart-type conditional branching structure based on the conditional branching structure information and text information of the extended specification, and
highlights a node of the flowchart-type conditional branching structure and corresponding text information of the extended specification when an indicator is placed on the node.

8. The test case generation apparatus according to claim 1,
wherein the mapping relationship information generated by the mapping relationship generation unit is assigned a confirmation-required flag when the description of the specification and the description of the extended specification cannot be associated.

9. The test case generation apparatus according to claim 8,
wherein the mapping relationship generation unit
displays, on a screen, a flowchart-type conditional branching structure based on the conditional branching structure information and text information of the extended specification, and
displays a confirmation-required symbol on or near a node of the flowchart-type conditional branching structure based on the confirmation-required flag assigned to the mapping relationship information.

10. The test case generation apparatus according to claim 1,
wherein the route information generation unit assigns a confirmation-required flag to the processing route information when the conditional branching structure cannot be expanded into branching patterns.

11. The test case generation apparatus according to claim 10,
wherein the route information generation unit
displays, on a screen, a flowchart-type conditional branching structure based on the conditional branching structure information and a route list table based on the processing route information,
displays a check mark on or near a branching pattern that can be expanded in the displayed conditional branching structure, and does not display the check mark on or near a branching pattern that cannot be expanded.

12. The test case generation apparatus according to claim 1,
wherein the route information generation unit
displays, on a screen, a flowchart-type conditional branching structure based on the conditional branching structure information and a route list table based on the processing route information, and
highlights a path of the flowchart-type conditional branching structure when an indicator is placed on the route list table.

13. A test case generation method executed by a computer to generate a test case from a specification written in natural language, comprising:
extracting specification information related to system development from the specification by a specification collection unit;
detecting, by a specification extension unit, an ambiguous expression of the specification and a corrected expression based on the specification information and an ambiguous expression knowledge database, supplementing the ambiguous expression included in ambiguous expression detection information using the specification or a similar specification having a predetermined degree of similarity to the specification, and generating an extended specification;
generating conditional branching structure information in which a conditional branching structure is constructed from the ambiguous expression detection information by a conditional branching structure generation unit;
generating mapping relationship information that associates a description of the specification and a description of the extended specification with node information relating to a node type extracted from the conditional branching structure information by a mapping relationship generation unit;
generating processing route information by scanning the conditional branching structure information, expanding the conditional branching structure into branching patterns, and assigning a route ID to each branching pattern by a route information generation unit; and
generating test case information including an input condition and an expected output based on completed mapping relationship information and the processing route information by a test case generation unit.
